(19) United States
(12) Patent Application Publication
(10) Pub. No.: US 2013/0268181 A1
(43) Pub. Date: Oct. 10, 2013

(54) Vehicle Control Device

(71) Applicants: Yoshiaki Nagasawa, Hitachinaka (JP); Eiichi Otsu, Mito (JP); Koji Onishi, Hitachinaka (JP); Kenichi Machida, Isesaki (JP); Shigehiko Omata, Mito (JP); Shigenori Nakazato, Mito (JP)

(72) Inventors: Yoshiaki Nagasawa, Hitachinaka (JP); Eiichi Otsu, Mito (JP); Koji Onishi, Hitachinaka (JP); Kenichi Machida, Isesaki (JP); Shigehiko Omata, Mito (JP); Shigenori Nakazato, Mito (JP)

(73) Assignee: Hitachi Automotive Systems, Ltd., Hitachinaka-shi (JP)

(21) Appl. No.: 13/994,553

(22) PCT Filed: Dec. 28, 2011
(86) PCT No.: PCT/JP2011/080357

§ 371 Date: Jun. 14, 2013

(30) Foreign Application Priority Data
Dec. 28, 2010 (JP) 2010-293913

(51) Int. Cl. F02D 41/04

(52) U.S. Cl. CPC F02D 41/04
USPC 701/112

(57) ABSTRACT

A vehicle control device is provided with an idle reduction system for performing automatic stopping and automatic starting of the internal combustion engine, where the idle reduction system includes a starter that separately causes movement of a pinion gear and driving of a motor, and a semiconductor switching element that controls the movement of the pinion gear and the driving of the motor, the control device being provided with a means for detecting or estimating that the internal combustion engine reversely rotates in a process in which the internal combustion engine stops rotating and a means for inhibiting the driving of the motor by the semiconductor switching element for a predetermined period of time in the case where the reverse rotation is detected or estimated.

### TECHNICAL FIELD

The present invention relates to a vehicle control device, and more particularly, to a vehicle control device provided with an idle reduction system, which automatically stops an internal combustion engine when an idle reduction condition of the vehicle is satisfied, and rapidly starts up the internal combustion engine to start moving when restarting moving.

### BACKGROUND ART

In a vehicle provided with an idle reduction system, a technique has already been put to practical use, in which fuel supply is blocked to stop an internal combustion engine when an automatic stop condition of the internal combustion engine is satisfied during driving thereof, and the internal combustion engine is rapidly started up to start moving, when a restart-up condition of the internal combustion engine is satisfied, according to an operation of a driver or a request of the vehicle.

In the vehicle provided with the idle reduction system, at the time of restart-up after idle reduction, a navigation system with high minimum operation voltage or electrical components may be reset and restarted by voltage drop of a battery by initial inrush current flowing in a starter motor.

In order to prevent this, a method of adding a DC-DC converter to raise battery voltage, and a technique of controlling energization current flowing in a starter motor at the time of initial inrush using a semiconductor switching element and a duty control to suppress voltage drop, are provided (see PTL 1).

Meanwhile, in a recent idle reduction system, a vehicle provided with so-called change-of-mind has put to practical use, in which an internal combustion engine is immediately restarted up to start moving the vehicle when acceleration is requested even while an idle reduction condition is satisfied and an internal combustion engine is in a stop process by fuel cut.

However, in the stop process of the internal combustion engine described above, in some cases, a piston cannot withstand a compression step and reverse rotation occurs. When a starter motor is driven by a semiconductor switching element during the reverse rotation, it is locked to cause an excessive load to be applied to the semiconductor switching element. Eventually, overcurrent flows in the semiconductor switching element for a long time, and thus the semiconductor switching element may burn out.

In order to prevent this, a countermeasure is necessary, such as using a semiconductor element with high current capacitance, using a mechanical contact point together, or inhibiting driving of a starter motor in a state where an internal combustion engine is in reverse rotation.

### CITATION LIST

### Patent Literature

PTL 1: Japanese Patent Application Laid-Open No. 2010-106825

### SUMMARY OF INVENTION

### Technical Problem

In an internal combustion engine for a vehicle, when supply of fuel is stopped during driving, the number of rotations is decreased, and in some cases, a phenomenon (reverse rotation) that a piston cannot withstand a compression step and is returned just before stopping occurs.

When restart-up is requested and the starter motor is driven during the reverse rotation to try cranking the internal combustion engine, if driving force of the starter motor is insufficient, it is locked to cause an excessive load to be applied. Eventually, current equal to or more than a permissible value flows in the semiconductor switching element, and thus the semiconductor switching element may burn out.

In order to avoid the cranking during the reverse rotation, it is necessary to drive the starter motor after waiting for complete end of the reverse rotation. However, in this way, a time lag of maximal several 100 ms is caused by the restart-up of the internal combustion engine from a start moving request of a driver, and a feeling of strangeness may be given to the driver.

The present invention is to avoid the problem, and an object of the present invention is to provide, in a vehicle provided with an idle reduction system, a vehicle control device which does not give a driver a feeling of strangeness when the internal combustion engine is restarted up, and particularly, a vehicle control device provided with an idle reduction system, in which a mechanical contact point is not added to a semiconductor switching element of the idle reduction system, cost-up based on large capacitance of the semiconductor switching element is suppressed, a breakdown of the semiconductor switching element is prevented, and the driver does not feels strangeness.

### Solution to Problem

In order to achieve the object, a vehicle control device of the present invention is provided with an idle reduction system performing automatic stop and automatic start-up of an internal combustion engine, wherein the idle reduction system includes a starter that separately causes movement of a pinion gear and driving of a motor; and a semiconductor switching element that controls the movement of the pinion gear and the driving of the motor, and wherein the control device includes a means for detecting or estimating that the internal combustion engine reversely rotates in a process in which the internal combustion engine stops rotating and a means for inhibiting the driving of the motor by the semiconductor switching element for a predetermined period of time when the reverse rotation is detected or estimated.

### Advantageous Effects of Invention

According to the present invention, in a state where backlash (reverse rotation) occurring just before the internal combustion engine stops based on idle reduction occurs, when restart-up is requested and a motor is driven, it is possible to prevent burnout of a semiconductor switching element caused by overload, and a feeling of strangeness is not given to a driver at the time of restart-up.

### BRIEF DESCRIPTION OF DRAWINGS

FIG. 1 is a diagram illustrating a functional configuration of an idle reduction system in a vehicle control device of the present invention.

FIG. 2 is a diagram illustrating a configuration of a control system of the vehicle control device of FIG. 1.

FIG. 3 is a flowchart illustrating a control of the vehicle control device of FIG. 1.

FIG. 4 is an operation chart of rotation synchronization pre-mesh of the idle reduction system of FIG. 1.

FIG. 5 is a diagram illustrating a rotation number behavior of an internal combustion engine at the time of idle reduction of the idle reduction system of FIG. 1.

### DESCRIPTION OF EMBODIMENTS

Hereinafter, embodiments of a vehicle control device of the present invention will be described with reference to the accompanying drawings.

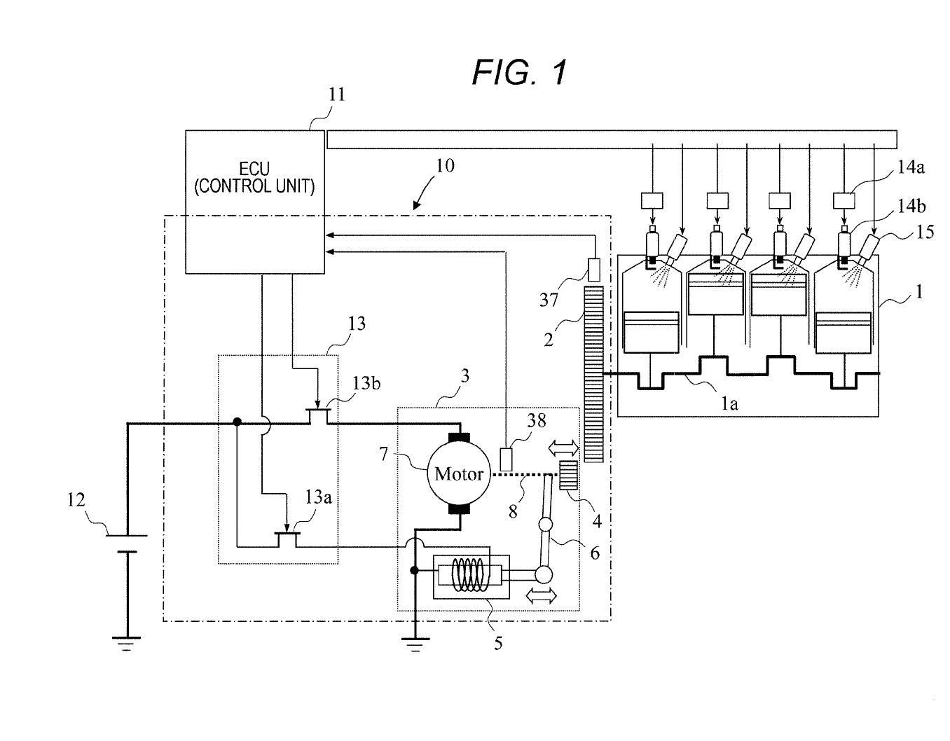

FIG. 1 is a diagram illustrating a functional configuration of an idle reduction system of an embodiment of the vehicle control device of the present invention.

In the functional configuration diagram of FIG. 1, the embodiment includes a multicylinder internal combustion engine body 1, a crank shaft la of the internal combustion engine body 1, an ignition coil 14a, an ignition plug 14b, a fuel injection valve 15, an idle reduction system 10, and an ECU (a control unit, a control device) 11. The idle reduction system 10 functionally constitutes a part of the ECU (the control unit, the control device) 11, and includes a pinion gear extrusion starter body 3 and a semiconductor switching element 13.

A ring gear 2 is mounted on the crank shaft 1a of the internal combustion engine body 1, and an actuator 5 and a motor 7 driven by the semiconductor switching element 13 and a pinion gear 4 are disposed in the starter body 3.

The ring gear 2 is provided with a ring gear sensor 37 of the ring gear 2 that converts unevenness of the gear into a pulse signal, and the ring gear sensor 37 detects the number of rotations of the internal combustion engine with high precision equal to or more than 100 pulses per rotation by performing a frequency-voltage conversion process in the ECU 11.

The starter body 3 includes the pinion gear 4 coming in contact with the ring gear 2, the actuator 5 that transfers the pinion gear 4, a shift lever 6 that transmits driving force of the actuator 5, the starter motor 7 that rotates the pinion gear 4, and a pinion gear sensor 38 that detects and outputs a pulse of a pinion shaft 8.

The pinion gear 4 is provided on the shaft (the pinion shaft) 8 of the starter motor 7 movably in the axial direction. When a pinion transfer instruction of the ECU is input to a gate terminal of the semiconductor switching element 13a, a battery power 12 is supplied to the actuator 5, and the shift lever 6 transfers the pinion gear 4 to the right side of the figure by a function of electromagnetic force, to engage with the ring gear 2.

Meanwhile, when a motor driving instruction from the ECU 11 is input to a gate terminal of the semiconductor switching element 13b, the battery power 12 is supplied to the starter motor 7 to drive the pinion gear 4 to rotate, and the starter motor 7 cranks the internal combustion engine body 1 through the engaged ring gear 2.

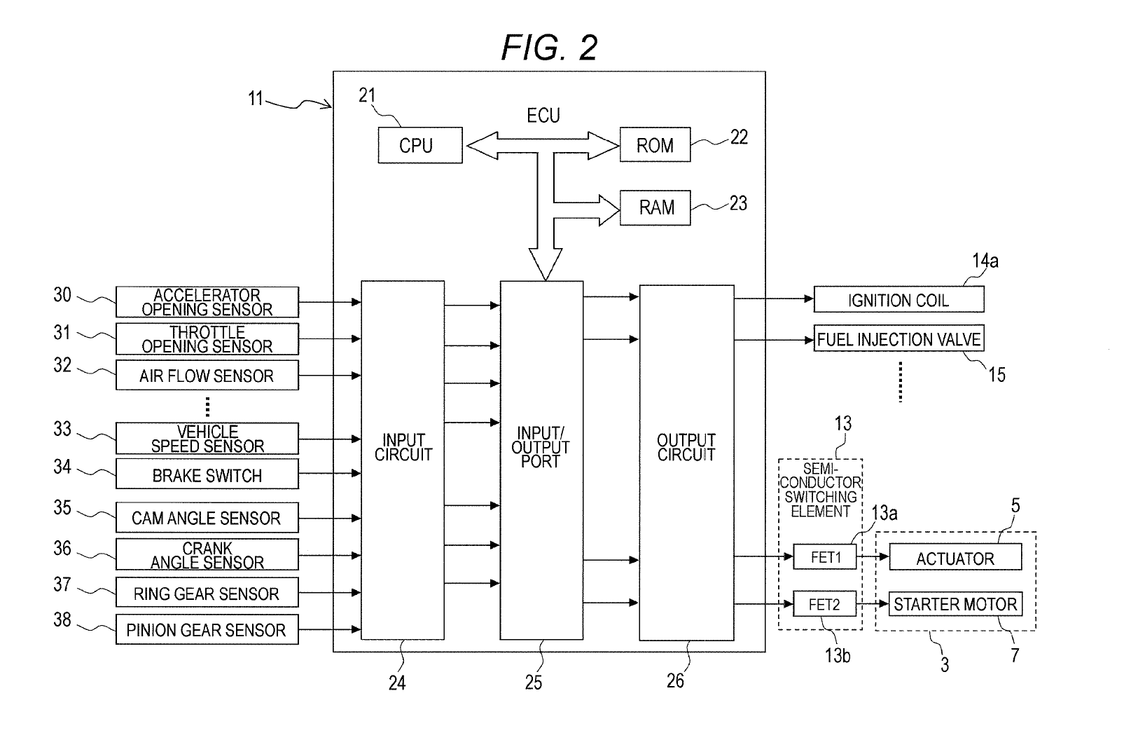

FIG. 2 is a diagram illustrating a system configuration of the ECU 11, which illustrates various input signals of the sensor or the like input to the ECU 11, and various output signals output from the ECU 11 to control apparatuses or the like.

An accelerator opening sensor 30 that detects a depression amount of an accelerator pedal of the vehicle, a throttle opening sensor 31 that detects an opening amount of a throttle valve, an air flow sensor 32 that measures an inhalation air amount inhaled into the cylinder of the internal combustion engine body 1, a vehicle speed sensor that detects a driving speed of the vehicle, a brake switch 34 that detects an operation of a foot brake, a cam angle sensor 35 and a crank angle sensor 36 that detect a cam angle signal and a crank angle signal used in calculation of ignition and injection timing of the internal combustion engine body 1 or cylinder determination, a ring gear sensor 37 that detects unevenness of the ring gear 2 of the internal combustion engine body 1 and outputs a pulse signal, and a pinion gear sensor 38 that detects a pulse signal of the pinion gear shaft 8 of the starter body 3, are input to an input circuit 24 of the ECU 11.

Meanwhile, the output circuit 26 is connected to the ignition coil 14a that supplies high voltage to the ignition plug 14b to ignite mixed gas in the cylinder at the timing calculated from the signals of the cam angle sensor 35 and the crank angle sensor 36, the fuel injection valve 15 that injects the fuel amount calculated on the basis of the inhalation air amount measured by the air flow sensor 32, and the semiconductor switching element 13 that outputs a PWM driving signal when a driving request to a starter 3 is received, to independently drive the actuator 5 and the motor 7.

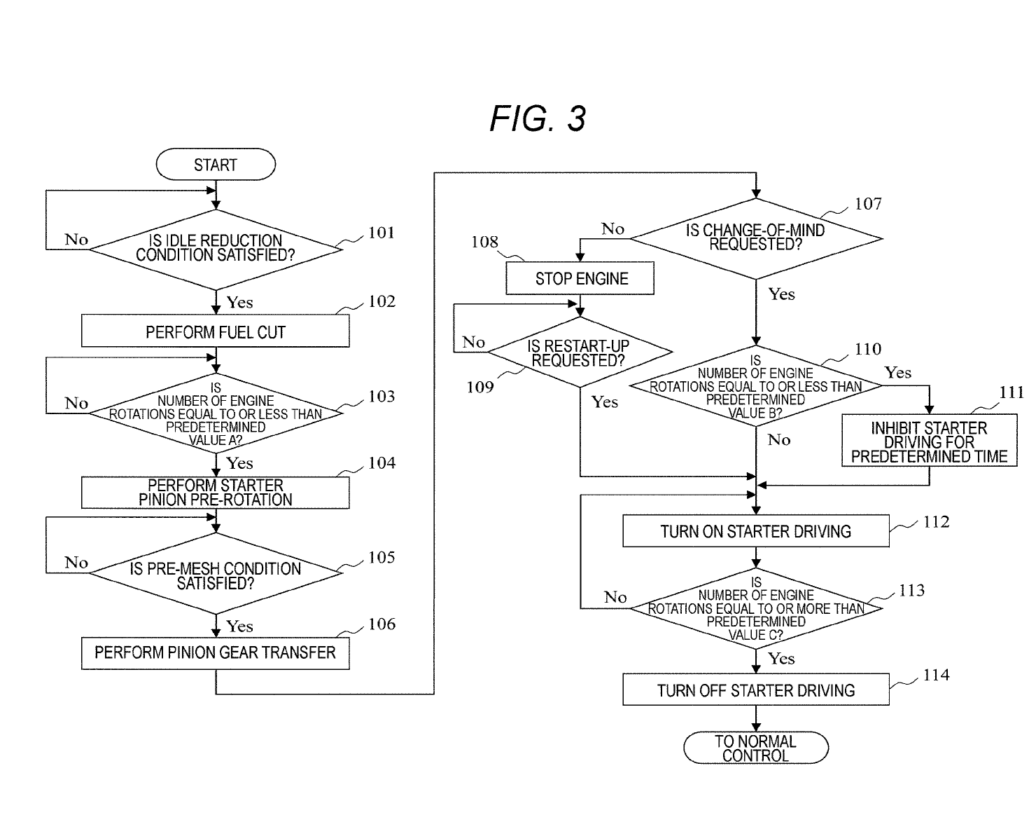

FIG. 3 is a control flowchart of the embodiment, and specifically, a flowchart of a rotation number synchronization pre-mesh of synchronizing the number of rotations of the pinion gear 4 with the number of rotations of the internal combustion engine at the time of idle reduction, to stop the internal combustion engine body 1 while allowing the pinion gear 4 to engage with the ring gear 2.

During the stand-by operation of the internal combustion engine 1, when each input condition of the vehicle speed sensor 33, the brake switch 34 or the like satisfies the idle reduction condition in Step 101, the driving of the fuel injection valve 15 is stopped to perform cut of the fuel supply (fuel cut) of the internal combustion engine in Step 102.

By the fuel cut operation, the number of rotations of the internal combustion engine gradually decreases. When the number of rotations is equal to or less than the predetermined value A of the determination condition in Step 103, the process proceeds to Step 104, a pinion pre-rotation operation, that is, an operation of energizing the starter motor 7 and raising the number of rotations of the pinion gear calculated from the pinion gear sensor 38 up to a predetermined value to stop energization, is performed.

In this case, by the pinion pre-rotation operation, the number of rotations of the pinion gear gradually decreases with time by inertia. Meanwhile, the number of rotations of the internal combustion engine decreases while repeating and pulsing intake→compression→exhaust. When the timing when the number of rotations of the internal combustion engine calculated from the ring gear sensor 37 is synchronized with the number of rotations of the pinion gear gradually decreasing by the pinion pre-rotation operation is predicted and the pre-mesh condition is satisfied in Step 105, the process proceeds to Step 106, and the pinion gear transfer is performed, that is, the energization to the starter actuator is started to be a so-called pre-mesh state of allowing the pinion gear to engage with the ring gear through the shift lever.

In Step 107, when it is determined that there is no change-of-mind request from the driver, the process proceeds to Step 108, and the internal combustion engine completely stops in the pre-mesh state. The process proceeds to Step 109, and a stand-by state is maintained until the restart-up request is received.

In the waiting state of Step 109, when the restart-up request is received by an operation or the like of the driver, the process proceeds to Step 112, the starter motor is energized, the fuel injection is started again to restart up the internal combustion engine.

In addition, in Step 107, when it is determined that there is the change-of-mind request from the driver, the process proceeds to. Step 110, and it is determined whether the number of engine rotations is equal to or less than a predetermined value B. When the number of engine rotations is not equal to or less than the predetermined value B, the process proceeds to Step 112. When the number of rotations of the internal combustion engine is equal to or less than the predetermined value B, the process proceeds to Step 111, the driving of the starter 3 is inhibited for a predetermined time, and then the process proceeds to Step 112.

Thereafter, the process proceeds to Step 113, and it is determined whether the number of engine rotations is equal to or more than a predetermined value C. When the number of engine rotations is equal to or more than the predetermined value C, the process proceeds to Step 114, and the driving of the starter 3 is turned off.

As described above, the rotation number synchronization pre-mesh operation between the pinion gear and the ring gear 2 is performed, it is possible to shorten the time until the pinion gear 4 engages with the ring gear 2, and thus it is possible to reduce the time when noise occurs at the time of engaging gears.

In addition, at the next restart-up time, it is possible to skip the time until the pinion gear 4 engages with the ring gear 2, and thus it is possible to shorten the start-up time until the internal combustion engine reaches complete explosion after the restart-up request is received.

The basic operation of the system performing the idle reduction in pre-mesh based on the rotation number synchronization is a pattern of restarting up after the internal combustion engine described above is completely stopped. However, according to the timing of the restart-up request of the driver, there is a state of performing the restart-up in a state where the internal combustion engine does not completely stop, such as a pattern of performing the restart-up just after fuel cut, a pattern of performing the restart-up just after pre-mesh, and a pattern of performing the restart-up during backlash (reverse rotation) just before the internal combustion engine stops by pre-mesh.

In the present application, such a pattern is called change-of-mind.

In the patterns of change-of-mind, there is no problem when the restart-up is performed from the pattern in which the internal combustion engine is rotated in the positive direction. However, when the restart-up is performed in the backlash (reverse rotation) state just before the internal combustion engine stops, an excessive load is applied to the semiconductor switching element driving the starter motor, overcurrent over the permission of the semiconductor switching element flows, and the semiconductor switching element may burn out.

As a method of preventing the burn-out caused by the overcurrent without increasing a cost, a method of inhibiting restart-up is conceivable during the detection of the reverse rotation. However, in order to determine that the reverse rotation state is completely ended by the ring gear pulse signal, the time of several 100 ms is necessary, the time from the change-of-mind instruction to the restart-up is delayed, and thus a feeling of strangeness is given to the driver.

The embodiment is to suppress the feeling of strangeness given to the driver as much as possible at the restart-up time in the change-of-mind, and to prevent the burn-out caused by flowing of the overcurrent in the semiconductor switching element, and it is possible to implement the embodiment without increasing the cost such as adding a mechanical contact point or using a high-capacitance semiconductor switching element.

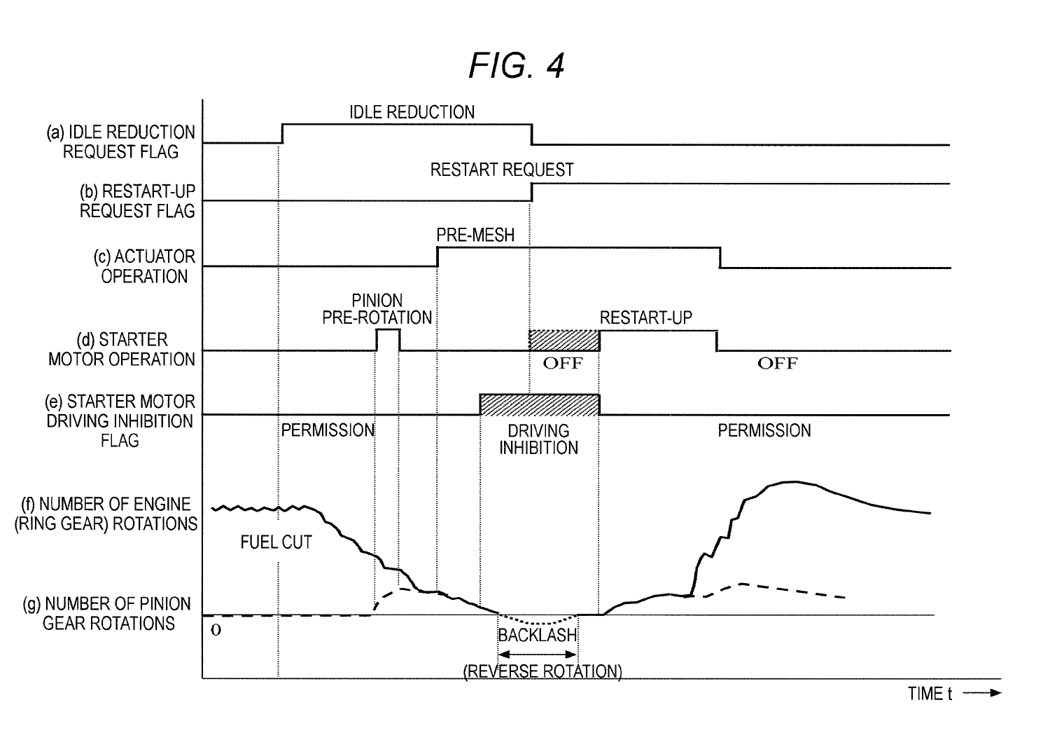

FIG. 4 is an example illustrating an internal combustion engine rotation number behavior (a control state) when stopping an internal combustion engine performing the rotation number synchronization pre-mesh operation in which the pinion gear 4 and the ring gear 2 engage with each other, with the lapse of time on the basis of a real machine.

In FIG. 4, a request flag (fuel cut) state of an idle reduction control is represented by (a), a request flag state of a restart-up control is represented by (b), an actuator operation state is represented by (c), a starter motor operation state is represented by (d), an inhibition flag state of starter motor driving is represented by (e), a rotation number state of an internal combustion engine (a ring gear) is represented by (f), and a rotation state of a pinion gear is represented by (g).

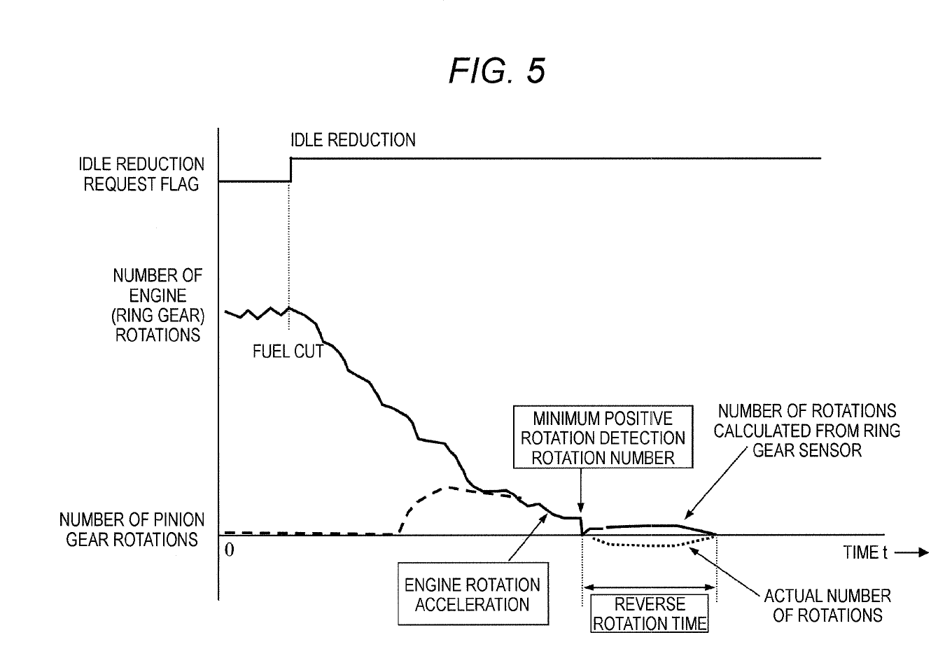

FIG. 5 is a diagram illustrating a rotation number behavior of the internal combustion engine at the time of idle reduction of the idle reduction system, and illustrates (f) and (g) of FIG. 4 in detail.

In the example, the internal combustion engine rotation number behavior is recorded many times, “internal combustion engine rotation acceleration” just before stop, “minimum positive rotation detection rotation number” that is the lowest number of rotations of the internal combustion engine capable of detecting the positive rotation state, and “reverse rotation time” up to the time of convergence of the reverse rotation from the number of rotations, are acquired from the recorded chart.

From the above description, in the process in which the internal combustion engine rotation is directed to stop, when the number of rotations of the internal combustion engine is the “minimum positive rotation detection rotation number”, it is estimated that the internal combustion engine reversely rotates, and then the motor driving by the semiconductor switching element 13 is inhibited until the “reverse rotation time” is elapsed.

However, from acceleration when the number of rotations of the internal combustion engine decreases, in a case equal to or less than acceleration in which the reverse rotation does not occur, the motor driving is permitted even within the “reverse rotation time”.

As described above, since it is possible to avoid the unnecessary inhibiting of the motor driving, it is possible that the feeling of strangeness is given to the driver as little as possible at the restart-up time.

In the system using the ring gear sensor 37 capable of detecting the reverse rotation of the internal combustion engine with high precision, the “minimum positive rotation detection rotation number” and “reverse rotation time” may have a configuration of learning the reverse rotation time to absorb difference in apparatuses or difference in time degradation.

In addition, the behavior of the internal combustion engine rotation number at the time of idle reduction has potential changed according to a warm-up state of the internal combustion engine or the transmission, a gear position, load of internal combustion engine auxiliary machines, and load of a gear position of the transmission. Accordingly, the “reverse rotation time” is tabulated in advance on the horizontal axis with respect to an internal combustion engine cooling water temperature, an internal combustion engine lubricant temperature, a transmission lubricant temperature, and the like, it is possible to use an optimal value even when the driving condition is changed, and thus it is possible to prevent the motor driving inhibition time from being unnecessarily extended.

### REFERENCE SIGNS LIST

1 internal combustion engine body
2 ring gear
3 starter
4 pinion gear
5 pinion transfer actuator
6 shift lever
7 starter motor
8 pinion shaft
10 idle reduction system
11 control unit (control device)
12 battery
13 semiconductor switching element
13a semiconductor switching element for driving pinion transfer actuator
13b semiconductor switching element for driving starter motor
14a ignition coil
14b ignition plug
15 fuel injection valve
37 ring gear sensor
38 pinion gear sensor

1. A vehicle control device provided with an idle reduction system performing automatic stop and automatic start-up of an internal combustion engine,
wherein the idle reduction system includes a starter that separately causes movement of a pinion gear and driving of a motor; and a semiconductor switching element that controls the movement of the pinion gear and the driving of the motor, and
the vehicle control device comprises a means for detecting or estimating that the internal combustion engine reversely rotates in a process in which the internal combustion engine stops rotating and a means for inhibiting the driving of the motor by the semiconductor switching element for a predetermined period of time when the reverse rotation is detected or estimated.

2. The vehicle control device according to claim 1, wherein when the number of rotations of a crank shaft of the internal combustion engine is smaller than a predetermined value, the means for estimating the reverse rotation estimates that the internal combustion engine reversely rotates.

3. The vehicle control device according to claim 1, wherein when acceleration of a crank shaft of the internal combustion engine is smaller than a predetermined value, the means for estimating the reverse rotation estimates that the internal combustion engine does not reversely rotate and stops.

4. (canceled)

5. The vehicle control device according to claim 1, wherein the driving inhibition time of the motor searches an optimal value from a constant table in which a cooling water temperature and a lubricant temperature of the internal combustion engine and a lubricant temperature of a transmission are parameters.

6. The vehicle control device according to claim 1, wherein the driving inhibition time of the motor searches a value of a condition from a plurality of constant tables classified into auxiliary machine load of the internal combustion engine and a gear position condition of a transmission.
